(19) United States
(12) Patent Application Publication
(10) Pub. No.: US 2013/0310497 A1
(43) Pub. Date: Nov. 21, 2013

(54) PHOTO-CURING POLYSILOXANE COMPOSITION AND APPLICATIONS THEREOF

(71) Applicant: CHI MEI CORPORATION, Tainan City (TW)

(72) Inventors: Ming-Ju Wu, Tainan City (TW); Chun-An Shih, Tainan City (TW)

(73) Assignee: Chi Mei Corporation, Tainan City (TW)

(21) Appl. No.: 13/875,903

(22) Filed: May 2, 2013

(30) Foreign Application Priority Data
May 15, 2012 (TW) 101117227

(51) Int. Cl. C08K 5/42; C08K 5/101

(52) U.S. Cl. CPC C08K 5/42; C08K 5/101
USPC 524/159

(57) ABSTRACT

A photo-curing polysiloxane composition for forming a protective film having superior chemical resistance and development resistance is disclosed. The photo-curing polysiloxane composition includes: a polysiloxane component including at least one polysiloxane having at least one alkenyl group; a quinonediazide compound; a fluorene derivative component including at least one fluorene derivative compound having at least one double-bond-containing group; and a solvent.

### CROSS-REFERENCE TO RELATED APPLICATION

This application claims priority of Taiwanese Application No. 101117227, filed on May 15, 2012.

### BACKGROUND OF THE INVENTION

1. Field of the Invention

This invention relates to a photo-curing polysiloxane composition, more particularly to a positive photo-curing polysiloxane composition including a polysiloxane and a fluorene derivative. This invention also relates to a protective film formed from the photo-curing polysiloxane composition, and an element containing the protective film.

2. Description of the Related Art

In recent years, in the field of semiconductor industry, liquid crystal displays, and organic electroluminescence displays, it is required that the pattern details in photolithography process be higher due to element miniaturization.

Positive type photosensitive materials with high resolution and high sensitivity are adopted to obtain miniaturized patterns via exposure and development. The positive type photosensitive material containing a polysiloxane composition has been widely used in the art.

JP 2008-107529 discloses a photosensitive resin composition capable of forming a cured film. The photosensitive resin composition includes a polysiloxane, a quinonediazidesulfonic acid ester, and a solvent. The polysiloxane contains an oxetanyl group or a succinic anhydride group, and is obtained by subjecting a silane monomer containing an oxetanyl group or a succinic anhydride group to hydrolysis and partial condensation. The photosensitive resin composition has photosensitivity acceptable for the photolithography process. Nevertheless, the cured film formed by the photosensitive resin composition has inferior chemical resistance. Furthermore, the development resistance of the cured film is unacceptable in the art. The pattern of the cured film is liable to be destroyed when the pattern formed after the development process contains residual development solution and is delayed for the subsequent washing and drying processes.

It is still required in the art to provide a photosensitive resin composition which can be used to form a protective film having superior chemical resistance and development resistance.

### SUMMARY OF THE INVENTION

A first object of this invention is to provide a photo-curing polysiloxane composition for forming a protective film having superior chemical resistance and development resistance.

A second object of this invention is to provide the protective film having superior chemical resistance and development resistance.

A third object of this invention is to provide an element having the protective film.

According to a first aspect of this invention, there is provided a photo-curing polysiloxane composition including: a polysiloxane component including at least one polysiloxane having at least one alkenyl group; a quinonediazide compound; a fluorene derivative component including at least one fluorene derivative compound having at least one double-bond-containing group; and a solvent.

According to a second aspect of this invention, there is provided a protective film formed by applying the photo-curing polysiloxane composition on a substrate.

According to a third aspect of this invention, there is provided an element including the protective film applied on the substrate.

In the present invention, a protective film with an intimate structure can be formed by a bridging reaction between the alkenyl group contained in the polysiloxane and the double-bond-containing group contained in the fluorene derivative compound. Undesirable swelling effect attributed to the solvent can be alleviated or even eliminated so as to enhance the chemical resistance of the protective film. Moreover, since the fluorene derivative compound having at least one double-bond-containing group is relatively inert to the development solution, the development resistance of the protective film can be effectively enhanced.

### DETAILED DESCRIPTION OF THE PREFERRED EMBODIMENTS

As used herein, the term “(meth)acrylate” means acrylate and/or methacrylate, and the term “(meth)acryloyloxy” means acryloyloxy and/or methacryloyloxy.

A photo-curing polysiloxane composition of the present invention includes a polysiloxane component (A), a quinonediazide compound (B), a fluorene derivative component (C), and a solvent (D).

### Polysiloxane Component (A):

The polysiloxane component (A) includes at least one polysiloxane having at least one alkenyl group. Preferably, the polysiloxane further has at least one reactive group selected from the group consisting of an anhydride group and an epoxy group.

The polysiloxane having at least one alkenyl group is obtained by subjecting a silane monomer component to condensation. The silane monomer component includes a silane monomer of Formula (a):

(R^{a})ₖSi(OR^{b})₄₋ₖ (a)

wherein

k denotes an integer ranging from 1 to 3,

at least one of R^{a} independently represents a C₂-C₁₀ alkenyl group, and the rest of R^{a} independently represents hydrogen, a C₁-C₁₀ alkyl group, an anhydride-substituted C₁-C₁₀ alkyl group, an epoxy-substituted C₁-C₁₀ alkyl group, an epoxy-substituted alkoxyl group, or a C₆-C₁₅ aryl group, and

R^{b} independently represents hydrogen, a C₁-C₆ alkyl group, a C₁-C₆ acyl group, or a C₆-C₁₅ aryl group.

In the definition of R^{a}, examples of the alkenyl group include, but are not limited to, vinyl, 3-acryloxypropyl, and 3-methacryloxypropyl. Examples of the alkyl group include, but are not limited to, methyl, ethyl, n-propyl, isopropyl, n-butyl, tert-butyl, n-hexyl, n-decyl, trifluoromethyl, 3,3,3-trifluoropropyl, 3-aminopropyl, 3-mercaptopropyl, and 3-isocyanatopropyl. Examples of the anhydride-substituted C₁-C₁₀ alkyl group include, but are not limited to, ethyl succinic anhydride, propyl succinic anhydride, and propyl glutaric anhydride. Examples of the epoxy-substituted C₁-C₁₀ alkyl group include, but are not limited to, oxetanylpentyl and (3,4-epoxycyclohexyl)ethyl. Examples of the epoxy-substituted alkoxy group include, but are not limited to, glycidoxypropyl and 2-oxetanylbutoxy. Examples of the aryl group include, but are not limited to, phenyl, tolyl, p-hydroxyphenyl, 1-(p-hydroxyphenyl)ethyl, 2-(p-hydroxyphenyl)ethyl, 4-hydroxy-5-(p-hydroxyphenylcarbonyloxy)pentyl, and naphthyl.

In the definition of R^{b}, examples of the alkyl group include, but are not limited to, methyl, ethyl, n-propyl, isopropyl, and n-butyl. A non-limiting example of the acyl group is acetyl. A non-limiting example of the aryl group is phenyl.

Examples of the silane monomer represented by Formula (a) include, but are not limited to, 3-acryoyloxypropyltrimethoxysilane (abbreviated as APP-TMS), 3-methylacryloyloxypropyltrimethoxysilane (abbreviated as MAPP-TMS), 3-methylacryloyloxypropyltriethoxysilane, vinyltrimethoxysilane (abbreviated as VTMS), and vinyltriethoxysilane. The aforesaid examples of the silane monomer represented by Formula (a) can be used alone or as a mixture of two or more.

Preferably, the silane monomer component further includes a silane monomer of Formula (a-1):

(R^{c})_{z}Si(OR^{d})_{4-z} (a-1)

wherein

z denotes an integer ranging from 0 to 3,

R^{c} is independently selected from the group consisting of hydrogen, a C₁-C₁₀ alkyl group, an anhydride-substituted C₁-C₁₀ alkyl group, an epoxy-substituted C₁-C₁₀ alkyl group, an epoxy-substituted alkoxy group, and a C₆-C₁₅ aryl group, and

R^{d} is independently selected from the group consisting of hydrogen, a C₁-C₆ alkyl group, a C₁-C₆ acyl group, and a C₆-C₁₅ aryl group.

In the definition of R^{c}, examples of the alkyl group include, but are not limited to, methyl, ethyl, n-propyl, isopropyl, n-butyl, tert-butyl, n-hexyl, n-decyl, trifluoromethyl, 1,3,3,3-trifluoropropyl, 3-aminopropyl, 3-mercaptopropyl, and 3-isocyanatopropyl. Examples of the anhydride-substituted C₁-C₁₀ alkyl group include, but are not limited to, ethyl succinic anhydride, propyl succinic anhydride, and propyl glutaric anhydride. Examples of the epoxy-substituted C₁-C₁₀ alkyl group include, but are not limited to, oxetanylpentyl and (3,4-epoxycyclohexyl)ethyl. Examples of the epoxy-substituted alkoxy group include, but are not limited to, glycidoxypropyl and 2-oxetanylbutoxy. Examples of the aryl group include, but are not limited to, phenyl, tolyl, p-hydroxyphenyl, 1-(p-hydroxyphenyl)ethyl, 2-(p-hydroxyphenyl)ethyl, 4-hydroxy-5-(p-hydroxyphenylcarbonyloxy)pentyl, and naphthyl.

In the definition of R^{d}, examples of the alkyl group include, but are not limited to, methyl, ethyl, n-propyl, isopropyl, and n-butyl. A non-limiting example of the acyl group is acetyl. A non-limiting example of the aryl group is phenyl.

Examples of the silane monomer represented by Formula (a-1) include, but are not limited to, 3-glycidoxypropyltrimethoxysilane (abbreviated as TMS-GAA), 3-glycidoxypropyltriethoxysi lane, 2-(3,4-epoxycyclohexyl)ethyltrimethoxysilane, and 2-oxetanylbutoxypropyltriphenoxysilane; commercially available products manufactured by Toagosei Co., Ltd., for example, 2-oxetanylbutoxypropyltrimethoxysilane (trade name: TMSOX-D), 2-oxetanylbutoxypropyltriethoxysilane (trade name: TESOX-D); commercially available products manufactured by Shin-Etsu Chemical Co., Ltd., for example, 3-trimethoxysilylpropyl succinic anhydride (trade name: X-12-967); commercially available products manufactured by Wacker Chemie AG, for example, 3-(triethoxysilyl)propyl succinic anhydride (trade name: GF-20), 3-(trimethoxysilyl)propyl glutaric anhydride (abbreviated as TMSG), 3-(triethoxysilyl)propyl glutaric anhydride, 3-(triphenoxysilyl)propyl glutaric anhydride, diisopropoxy-di(2-oxetanylbutoxypropyl)silane (abbreviated as DIDOS), di(3-oxetanylpentyl)dimethoxy silane, (di-n-butoxysilyl) di(propyl succinic anhydride), (dimethoxysilyl) di(ethyl succinic anhydride), 3-glycidoxypropyldimethylmethoxysilane, 3-glycidoxypropyldimethylethoxysilane, di(2-oxetanylbutoxypentyl)-2-oxetanylpentylethoxy silane, tri(2-oxetanylpentyl)methoxy silane, (phenoxysilyl) tri(propyl succinic anhydride), (methylmethoxysilyl) di(ethyl succinic anhydride), tetramethoxysilane, tetraethoxysilane, tetraacetoxysilane, tetraphenoxy silane, methyltrimethoxysilane (abbreviated as MTMS), methyltriethoxysilane, methyltriisopropoxysilane, methyltri-n-butoxysilane, ethyltrimethoxysilane, ethyltriethoxysilane, ethyltriisopropoxysilane, ethyl tri-n-butoxysilane, n-propyltrimethoxysilane, n-propyltriethoxysilane, n-butyltrimethoxysilane, n-butyltriethoxysi lane, n-hexyltrimethoxysilane, n-hexyltriethoxysilane, decyltrimethoxysilane, phenyltrimethoxysilane (abbreviated as PTMS), phenyltriethoxysilane (abbreviated as PTES), p-hydroxyphenyltrimethoxysilane, 1-(p-hydroxyphenyl)ethyltrimethoxysilane, 2-(p-hydroxyphenyl)ethyltrimethoxysilane, 4-hydroxy-5-(p-hydroxyphenylcarbonyloxy)pentyltrimethoxysilane, trifluoromethyltrimethoxysilane, trifluoromethyltriethoxysilane, 3,3,3-trifluoropropyltrimethoxysilane, 3-aminopropyltrimethoxysilane, 3-aminopropyltriethoxysilane, dimethyldimethoxysilane (abbreviated as DMDMS), dimethyldiethoxysilane, dimethyldiacetyloxysilane, di-n-butyldimethoxysilane, diphenyldimethoxysilane, trimethylmethoxysilane, tri-n-butylethoxysilane, and 3-mercaptopropyltrimethoxysilane. The aforesaid examples of the silane monomer represented by Formula (a-1) can be used alone or as a mixture of two or more.

Preferably, the silane monomer component further includes a siloxane prepolymer of Formula (a-2):

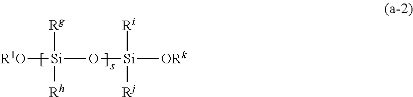

wherein

R^{g}, R^{h}, Rⁱ and R^{j} independently represent a hydrogen atom, a substituted or unsubstituted C₁-C₁₀ alkyl group, a substituted or unsubstituted C₂-C₆ alkenyl group, or a substituted or unsubstituted C₆-C₁₅ aryl group. The plural R^{g}s can be identical with or different from each other and the plural R^{h}s can be identical with or different from each other when s ranges from 2 to 1,000. Examples of the alkyl group include, but are not limited to, methyl, ethyl, and n-propyl. Examples of the alkenyl group include, but are not limited to, vinyl, acryloxypropyl, and methacryloxypropyl. Examples of the aryl group include, but are not limited to, phenyl, tolyl, and naphthyl.

R^{l} and R^{k} independently represent a hydrogen atom, a substituted or unsubstituted C₁-C₆ alkyl group, a substituted or unsubstituted C₁-C₆ acyl group, or a substituted or unsubstituted C₆-C₁₅ aryl group. Examples of the alkyl group include, but are not limited to, methyl, ethyl, n-propyl, isopropyl, and n-butyl. A non-limiting example of the acyl group is acetyl. A non-limiting example of the aryl group is phenyl.

In Formula (a-2), s is an integer ranging from 1 to 1,000, preferably from 3 to 300, and more preferably from 5 to 200.

Examples of the siloxane prepolymer represented by formula (a-2) include, but are not limited to, 1,1,3,3-tetramethyl-1,3-dimethoxy disiloxane, 1,1,3,3-tetramethyl-1,3-diethoxydisiloxane, 1,1,3,3-tetraethyl-1,3-diethoxydisiloxane, and commercially available silanol terminal polysiloxanes manufactured by Gelest Inc. (for example, DM-S 12 (molecular weight: 400-700), DMS-S15 (molecular weight: 1,500-2,000), DMS-S21 (molecular weight: 4,200), DMS-S27 (molecular weight: 18,000), DMS-S31 (molecular weight: 26,000), DMS-S32 (molecular weight: 36,000), DMS-S33 (molecular weight: 43,500), DMS-S35 (molecular weight: 49,000), DMS-S38 (molecular weight: 58,000), DMS-S42 (molecular weight: 77,000), PDS-9931 (molecular weight: 1,000-1,400), and the like). The aforesaid examples of the siloxane prepolymer can be used alone or as a mixture of two or more.

Preferably, the silane monomer component also includes silicon dioxide particles. There is no specific limitation to the mean particle size of the silicon dioxide particles. The mean particle size of the silicon dioxide particles ranges generally from 2 nm to 250 nm, preferably from 5 nm to 200 nm, and more preferably from 10 nm to 100 nm.

Examples of the silicon dioxide particles include, but are not limited to, commercially available products manufactured by JGC Catalysts and Chemicals Ltd., for example, OSCAR 1132 (particle size: 12 nm, dispersant: methanol), OSCAR 1332 (particle size: 12 nm, dispersant: n-propanol), OSCAR 105 (particle size: 60 nm, dispersant: γ-butyrolactone), OSCAR 106 (particle size: 120 nm, dispersant: diacetone alcohol), and the like; commercially available products manufactured by Fuso Chemical Co., Ltd., for example, Quartron PL-1-IPA (particle size: 13 nm, dispersant: isopropanone), Quartron PL-1-TOL (particle size: 13 nm, dispersant: toluene), Quartron PL-2L-PGME (particle size: 18 nm, dispersant: propylene glycol monomethyl ether), Quartron PL-2L-MEK (particle size: 18 nm, dispersant: methyl ethyl ketone), and the like; and commercially available products manufactured by Nissan Chemical, for example, IPA-ST (particle size: 12 nm, dispersant: isopropanol), EG-ST (particle size: 12 nm, dispersant: ethylene glycol), IPA-ST-L (particle size: 45 nm, dispersant: isopropanol), IPA-ST-ZL (particle size: 100 nm, dispersant: isopropanol), and the like. The aforesaid examples of the silicon dioxide particles can be used alone or as a mixture of two or more.

The condensation can be conducted in a manner well known in the art. For example, a solvent, water, and optionally a catalyst are added to the silane monomer component, followed by stirring at a temperature ranging from 50° C. to 150° C. for 0.5 hour to 120 hours. During stirring, the by-products, such as alcohols, water, and the like, can be removed by distillation, if necessary.

There is no specific limitation to the solvent, which can be identical with or different from the solvent (D) contained in the photo-curing polysiloxane composition. Preferably, the solvent is used in an amount ranging from 15 g to 1,200 g, preferably from 20 g to 1,100 g, and more preferably from 30 g to 1,000 g based on 100 g of the silane monomer component.

The amount of water for the hydrolysis ranges from 0.5 mole to 2 moles based on 1 mole of the hydrolyzable groups contained in the silane monomer component.

There is no specific limitation to the catalyst, and an acid catalyst or a base catalyst can be preferably used. Examples of the acid catalyst include, but are not limited to, hydrochloric acid, nitric acid, sulfuric acid, hydrofluoric acid, oxalic acid, phosphoric acid, acetic acid, trifluoroacetic acid, formic acid, polycarboxylic acids and anhydrides thereof, and ion exchange resins. Examples of the base catalyst include, but are not limited to, diethylamine, triethylamine, tripropylamine, tributylamine, tripentylamine, trihexylamine, triheptylamine, trioctylamine, diethanolamine, triethanolamine, sodium hydroxide, potassium hydroxide, alkoxysilanes containing an amino group, and ion exchange resins.

Preferably, the catalyst is used in an amount ranging generally from 0.005 g to 15 g, preferably from 0.01 g to 12 g, and more preferably from 0.05 g to 10 g based on 100 g of the silane monomer component.

In view of storage stability, it is preferable that the by-products (for example, alcohols and water) and the catalyst are not contained in the polysiloxane component (A) produced after condensation. Therefore, it is preferable to purify the polysiloxane component (A). There is no specific limitation to the purification method. Preferably, the polysiloxane component (A) is diluted with a hydrophobic solvent, and an organic layer washed with water several times is then concentrated with an evaporator to remove alcohols or water. Additionally, the catalyst can be removed using ion exchange resin.

If the polysiloxane component (A) does not include the polysiloxane having at least one alkenyl group, a protective film with an intimate structure cannot be formed via the aforesaid bridging reaction between the alkenyl group contained in the polysiloxane and the double-bond-containing group contained in the fluorene derivative compound. Undesirable swelling effect may occur due to the solvent, and the chemical resistance of the protective film is inferior.

### Quinonediazide Compound (B):

There is no specific limitation to the quinonediazide compound (B) suitable in the photo-curing polysiloxane composition of the present invention. The quinonediazide compound (B) can be a fully or partially esterified compound. Preferably, the quinonediazide compound (B) is obtained via a reaction of quinonediazidesulfonic acid or salt thereof with a hydroxyl compound. More preferably, the quinonediazide compound (B) is obtained via a reaction of quinonediazidesulfonic acid or salt thereof with a polyhydroxyl compound.

Examples of the quinonediazidesulfonic acid include, but are not limited to, o-naphthoquinonediazide-4-sulfonic acid, o-naphthoquinonediazide-5-sulfonic acid, and o-naphthoquinonediazide-6-sulfonic acid. A non-limiting example of the salt of o-naphthoquinonediazidesulfonic acid is halide of o-naphthoquinonediazidesulfonic acid.

Examples of the hydroxyl compound include, but are not limited to:

(1)hydroxybenzophenone compounds, for example, but not limited to, 2,3,4-trihydroxybenzophenone, 2,4,4′-trihydroxybenzophenone, 2,4,6-trihydroxybenzophenone, 2,3,4,4′-tetrahydroxybenzophenone, 2,4,2′,4′-tetrahydroxybenzophenone, 2,4,6,3′,4′-pentahydroxybenzophenone, 2,3,4,2′,4′-pentahydroxybenzophenone, 2,3,4,2′,5′-pentahydroxybenzophenone, 2,4,5,3′,5′-pentahydroxybenzophenone, and 2,3,4,3′,4′,5′-hexahydroxybenzophenone.
(2) hydroxyaryl compounds, for example, but not limited to, a hydroxyaryl compound represented by Formula (I):

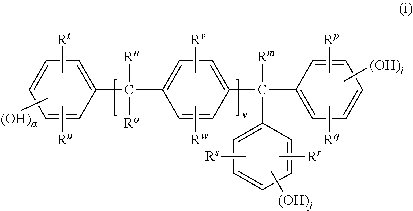

wherein

R^{m}, Rⁿ, and R^{o} independently represent a hydrogen atom or a C₁-C₆ alkyl group;

R^{p}, R^{q}, R^{r}, R^{s}, R^{t}, and R^{u} independently represent a hydrogen atom, a halogen atom, a C₁-C₆ alkyl group, a C₁-C₆ alkoxy group, a C₁-C₆ alkenyl group, or a cycloalkyl group;

R^{v} and R^{w} independently represent a hydrogen atom, a halogen atom, or a C₁-C₆ alkyl group;

i, j, and a independently denote an integer ranging from 1 to 3; and

v is 0 or 1.

Examples of the hydroxyaryl compound represented by Formula (I) include, but are not limited to, tri(4-hydroxyphenyl)methane, bis(4-hydroxy-3,5-dimethylphenyl)-4-hydroxyphenylmethane, bis(4-hydroxy-3,5-dimethylphenyl)-3-hydroxyphenylmethane, bis(4-hydroxy-3,5-dimethylphenyl)-2-hydroxyphenylmethane, bis(4-hydroxy-2,5-dimethylphenyl)-4-hydroxyphenylmethane, bis(4-hydroxy-2,5-dimethylphenyl)-3-hydroxyphenylmethane, bis(4-hydroxy-2,5-dimethylphenyl)-2-hydroxyphenylmethane, bis(4-hydroxy-3,5-dimethylphenyl)-3,4-dihydroxyphenylmethane, bis(4-hydroxy-2,5-dimethylphenyl)-3,4-dihydroxyphenylmethane, bis(4-hydroxy-3,5-dimethylphenyl)-2,4-dihydroxyphenylmethane, bis(4-hydroxy-2,5-dimethylphenyl)-2,4-dihydroxyphenyl methane, bis(4-hydroxyphenyl)-3-methoxy-4-hydroxyphenylmethane, bis(3-cyclohexyl-4-hydroxyphenyl)-3-hydroxyphenylmethane, bis(3-cyclohexyl-4-hydroxyphenyl)-2-hydroxyphenylmethane, bis(3-cyclohexyl-4-hydroxyphenyl)-4-hydroxyphenyl methane, bis(3-cyclohexyl-4-hydroxy-6-methylphenyl)-2-hydroxyphenylmethane, bis(3-cyclohexyl-4-hydroxy-6-methylphenyl)-3-hydroxyphenylmethane, bis(3-cyclohexyl-4-hydroxy-6-methylphenyl)-4-hydroxyphenylmethane, bis(3-cyclohexyl-4-hydroxy-6-methylphenyl)-3,4-di hydroxyphenyl methane, bis(3-cyclohexyl-6-hydroxyphenyl)-3-hydroxyphenylmethane, bis(3-cyclohexyl-6-hydroxyphenyl)-4-hydroxyphenylmethane, bis(3-cyclohexyl-6-hydroxyphenyl)-2-hydroxyphenylmethane, bis(3-cyclohexyl-6-hydroxy-4-methylphenyl)-2-hydroxyphenylmethane, bis(3-cyclohexyl-6-hydroxy-4-methylphenyl)-4-hydroxyphenyl methane, bis(3-cyclohexyl-6-hydroxy-4-methylphenyl)-3,4-dihydroxyphenylmethane, 1-[1-(4-hydroxyphenyl)isopropyl]-4-[1,1-bis(4-hydroxyphenyl)ethyl]benzene, and 1-[1-(3-methyl-4-hydroxyphenyl)isopropyl]-4-[1,1-bis(3-methyl-4-hydroxyphenyl)ethyl]benzene.

(3) (hydroxyphenyl)hydrocarbon compounds, for example, but not limited to, a (hydroxyphenyl)hydrocarbon compound represented by Formula (ii):

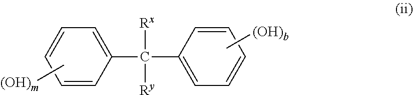

wherein

R^{x} and R^{y} independently represent a hydrogen atom or a C₁-C₆ alkyl group; and

b and m independently represent an integer ranging from 1 to 3.

Examples of the (hydroxyphenyl)hydrocarbon compound represented by Formula (ii) include, but are not limited to, 2-(2,3,4-trihydroxyphenyl)-2-(2′,3′,4′-trihydroxyphenyl)propane, 2-(2,4-dihydroxyphenyl)-2-(2′,4′-dihydroxyphenyl)propane, 2-(4-hydroxyphenyl)-2-(4′-hydroxyphenyl)propane, bis(2,3,4-trihydroxyphenyl)methane, and bis(2,4-dihydroxyphenyl)methane.

(4) other aromatic hydroxyl compounds, for example, but not limited to, phenol, p-methoxyphenol, dimethylphenol, hydroquinone, bisphenol A, naphthol, pyrocatechol, pyrogallol monomethyl ether, pyrogallol-1,3-dimethyl ether, gallic acid, and partially esterified or partially etherified gallic acid.

The aforesaid examples of the hydroxyl compounds can be used alone or as a mixture of two or more.

Preferably, the hydroxyl compound is selected from 1-[1-(4-hydroxyphenyl)isopropyl]-4-[1,1-bis(4-hydroxyphenyl)ethyl]benzene, 2,3,4-trihydroxybenzophenone, 2,3,4,4′-tetrahydroxybenzophenone, and combinations thereof.

The reaction of o-naphthoquinonediazidesulfonic acid or salt thereof with the hydroxyl compound is often conducted in an organic solvent such as dioxane, N-pyrrolidone, acetamide, and the like, in the presence of an alkali condensation agent such as triethanolamine, alkali carbonate, alkali hydrogen carbonate, and the like.

Preferably, the esterification rate of the quinonediazide compound (B) is more than 50%. That is, more than 50% by mole of the hydroxyl group contained in the hydroxyl compound undergoes an esterification reaction with o-naphthoquinonediazidesulfonic acid or salt thereof, based on 100% by mole of the total hydroxyl group contained in the hydroxyl compound. More preferably, the esterification rate of the quinonediazide compound (B) is more than 60%.

The quinonediazide compound (B) is used in an amount ranging from 1 part by weight to 50 parts by weight, preferably from 2 parts by weight to 40 parts by weight, and more preferably from 3 parts by weight to 30 parts by weight based on 100 parts by weight of the polysiloxane component (A).

### Fluorene Derivative Component (C):

The fluorene derivative component (C) includes at least one fluorene derivative compound having at least one double-bond-containing group. The term “double-bond-containing group” means an alkenyl group (for example, vinyl, allyl, and the like) or a group having a double bond (for example, an acrylate group, and the like).

Preferably, the fluorene derivative compound is represented by formula (I):

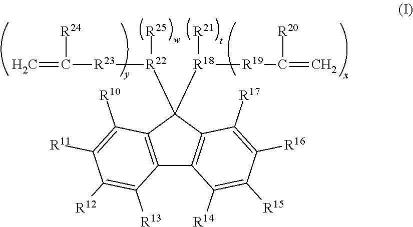

wherein

R¹⁰-R¹⁷ independently represent hydrogen, halo, cyano, or an alkyl group;

R¹⁸ and R²² independently represent an aryl group or a heterocyclic group;

R¹⁹ and R²³ independently represent a single bond or an organic group;

R²⁰ and R²⁴ independently represent hydrogen or methyl;

R²¹ and R²³ independently represent hydrogen, halo, an alkyl group, a cycloalkyl group, an aryl group, an alkaryl group, an alkoxyl group, a cycloalkyloxy group, an aryloxy group, an acyl group, nitro, cyano, or amino;

x and y independently represent an integer ranging from 1 to 3; and

w and t independently represent an integer ranging from 0 to 3.

In the definition of R¹⁰-R¹⁷, examples of halo include, but are not limited to, fluoro and chloro. The alkyl group represents a C₁-C₈ straight or branched alkyl group. Examples of the C₁-C₈ alkyl group include, but are not limited to, methyl and ethyl.

In the definition of R¹⁸ and R²², the aryl group represents a C₆-C₁₄ aryl group. Examples of the C₆-C₁₄ aryl group include, but are not limited to, phenyl, naphthyl, anthranyl, biphenylyl, indenyl, and the like. Preferably, the C₆-C₁₄ aryl group is selected from phenyl and naphthyl.

In the definition of R¹⁹ and R²³, examples of the organic group include, but are not limited to, an ester group, a combination of an ester group and an ether group, a siloxy group, a urethane group, and a combination of a urethane and an ether group. Preferably, the organic group is an ester group obtained by subjecting a fluorene derivative compound containing R¹⁸ and R²² groups substituted with a hydroxyl group or a glycidyl group and a (meth)acrylic compound containing at least one carboxyl group or an anhydride compound containing at least one anhydride group to a reaction; an ester group obtained by subjecting a fluorene derivative compound containing R¹⁸ and R²² groups substituted with a carboxyl group and hydroxyalkyl (meth)acrylate or glycidoxy(meth)acrylate to a reaction; or a urethane group obtained by subjecting a fluorene derivative compound containing R¹⁸ and R²² groups substituted with a hydroxyl group or a glycidyl group and a (meth)acrylate compound containing a terminal isocyanate group to a reaction. A non-limiting example of the (meth)acrylic compound containing at least one carboxyl group is (meth)acrylic acid. A non-limiting example of the anhydride compound containing at least one anhydride group is maleic anhydride. The (meth)acrylate compound containing a terminal isocyanate group is a product obtained by subjecting hydroxyalkyl (meth)acrylate and diisocyanate to a reaction, or a product obtained by subjecting hydroxyalkyl (meth)acrylate, diisocyanate, and diol to a reaction. Examples of the (meth)acrylate compound containing a terminal isocyanate group include, but are not limited to, (meth)acryloyloxyalkyl isocyanate and (meth)acryloyloxyphenyl isocyanate. Examples of (meth)acryloyloxyalkyl isocyanate include, but are not limited to, 2-(meth)acryloyloxy ethyl isocyanate, 6-(meth)acryloyloxy hexyl isocyanate, and 2,2-bis(meth)acryloyloxymethyl ethyl isocyanate. A non-limiting example of (meth)acryloyloxyphenyl isocyanate is 4-(meth)acryloyloxy phenyl isocyanate.

In addition, the organic group may be a siloxy group obtained by subjecting a fluorene derivative compound containing R¹⁸ and R²² groups substituted with a hydroxyl group and a silicon-containing coupling agent having an ethylenic unsaturated group or a (meth)acryloyloxy group to a reaction.

There is no specific limitation to the positions of R¹⁹ and R²³ at R¹⁸ and R²². Preferably, when R¹⁸ and R²² are phenyl, R¹⁹ and R²³ may be at position 3 or 4 of R¹⁸ and R²². When R¹⁸ and R²² are naphthyl, R¹⁹ and R²³ may be at position 4, 5, 6, or 7 of R¹⁸ and R²².

In the definition of R²¹ and R²⁵, examples of halo include, but are not limited to, fluoro and chloro. The alkyl group represents a C₁-C₈ straight or branched alkyl group. Examples of the C₁-C₈ alkyl group include, but are not limited to, methyl, ethyl, n-propyl, iso-propyl, n-butyl, tert-butyl, and iso-butyl. The cycloalkyl group represents a C₅-C₁₀ cycloalkyl group. Examples of the C₅-C₁₀ cycloalkyl group include, but are not limited to, cyclopentyl and cyclohexyl. The aryl group represents a C₆-C₁₀ aryl group. Examples of the C₆-C₁₀ aryl group include, but are not limited to, phenyl and naphthyl. The alkaryl group represents a combination of a C₁-C₄ alkyl group and a C₆-C₁₀ aryl group. Examples of the alkaryl group include, but are not limited to, benzyl, ethylphenyl, tolyl, xylyl, and tert-butylphenyl. The alkoxy group represents a C₁-C₈ alkoxy group. Examples of the C₁-C₈ alkoxy group include, but are not limited to, methoxy, ethoxy, propoxy, butoxy, tert-butoxy, and iso-butoxy. The cycloalkyloxy group represents a C₅-C₁₀ cycloalkyloxy group. A non-limiting example of the C₅-C₁₀ cycloalkyloxy group is cyclohexyloxy. The aryloxy group represents a C₆-C₁₀ aryloxy group. A non-limiting example of the C₆-C₁₀ aryloxy group is phenoxy. The acyl group represents a C₁-C₆ acyl group. A non-limiting example of the C₁-C₆ acyl group is acetyl. The amino group includes —NH₂ and a substituted amino group (for example, a C₁-C₆ alkyl substituted amino group). There is no specific limitation to the positions of R²¹ and R²⁵ at R¹⁸ and R²². Preferably, when R¹⁸ and R²² are phenyl, R²¹ and R²⁵ may be at position 2, 3, or 4 of R¹⁸ and R²². When R¹⁸ and R²² are naphthyl, R²¹ and R²⁵ may be at position 4, 5, 6, or 7 of R¹⁸ and R²².

Preferably, R²¹ and R²⁵ independently represent a C₁-C₄ alkyl group, phenyl, or a C₁-C₄ alkoxy group. More preferably, R²¹ and R²⁵ independently represent methyl, ethyl, phenyl, methoxy, or ethoxy. Preferably, x and y independently represent 1 or 2, and w and t independently represent 0 or 1.

Preferably, the fluorene derivative compound is represented by formula (II):

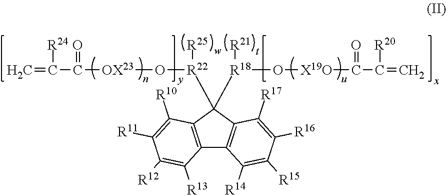

wherein

R¹⁰-R¹⁷ independently represent hydrogen, halo, cyano, or an alkyl group;

R¹⁸ and R²² independently represent an aryl group or a heterocyclic group;

X¹⁹ and X²³ independently represent an alkylene group;

R²⁹ and R²⁴ independently represent hydrogen or methyl;

R²⁰ and R²⁵ independently represent hydrogen, halo, an alkyl group, a cycloalkyl group, an aryl group, an alkaryl group, an alkoxyl group, a cycloalkyloxy group, an aryloxy group, an acyl group, nitro, cyano, or amino;

x and y independently represent an integer ranging from 1 to 3;

w and t independently represent an integer ranging from 0 to 3; and

n and u independently represent an integer ranging from 0 to 10.

The definitions of the halo and alkyl group in R¹⁰-R¹⁷ of formula (II) are the same as the definitions of those in R¹⁰-R¹⁷ of formula (I). The definitions of the aryl group and the heterocyclic group in R′⁸ and R²² of formula (II) are the same as the definitions of those in R′⁸ and R²² of formula (I). The definitions of the halo, the alkyl group, the cycloalkyl group, the aryl group, the alkaryl group, the alkoxyl group, the cycloalkyloxy group, the aryloxy group, the acyl group, the amino group in R²¹ and R²⁵ of formula (H) are the same as the definitions of those in R²¹ and R²⁵ of formula (I).

In the definition of X¹⁹ and X²³, the alkylene group represents a C₂-C₆ straight or branched alkylene group, for example, but not limited to, ethylene, propylene, trimethylene, and tetramethylene. Preferably, the alkylene group is a C₂-C₄ straight alkylene or a C₂-C₆ branched alkylene group. Preferably, n and u independently represent an integer ranging from 1 to 7. More preferably, n and u independently represent an integer ranging from 1 to 5.

Examples of the fluorene derivative compound include, but are not limited to, 9,9′-bis{[(meth)acryloxy]phenyl}fluorene compounds, 9,9′-bis{[(meth)acryloxyalkoxy]phenyl}fluorene compounds, 9,9′-bis{monoalkyl[2-(meth)acryloxyalkoxy]phenyl}fluorene compounds, 9,9′-bis{dialkyl-[2-(meth)acryloxyalkoxy]phenyl}fluorene compounds, 9,9′-bis{di[2-(meth)acryloxyalkoxy]phenyl}fluorene compounds, 9,9′-bis{tri[2-(meth)acryloxyalkoxy]phenyl}fluorene compounds, 9,9′-bis{[phenyl-(meth)acryloxyalkoxy]phenyl}fluorene compounds, and 9,9′-bis{[(meth)acryloxyalkoxy]naphthyl}fluorene compounds.

A non-limiting example of the 9,9′-bis {[(meth)acryloxy]phenyl}fluorene compounds is 9,9′-bis{[4-(meth)acryloxy]phenyl}fluorene.

Examples of the 9,9′-bis{[(meth)acryloxyalkoxy]phenyl}fluorene compounds include, but are not limited to, 9,9′-bis{4-[2-(meth)acryloxyethoxy]phenyl}fluorene, 9,9′-bis{4-[2-[2-(meth)acryloxyethoxy]ethoxy]phenyl}fluorene, and 9,9′-bis{4-[2-(meth)acryloxypropoxy]phenyl}fluorene.

Examples of the 9,9′-bis{monoalkyl[2-(meth)acryloxyalkoxy]phenyl}fluorene compounds include, but are not limited to, 9,9′-bis{3-methyl-4-[2-(meth)acryloxyethoxy]phenyl}fluorene, and 9,9′-bis{3-methyl-4-[2-(meth)acryloxypropoxy]phenyl}fluorene.

Examples of the 9,9′-bis{dialkyl[2-(meth)acryloxyalkoxy]phenyl}fluorene compounds include, but are not limited to, 9,9′-bis{3,5-dimethyl-4-[2-(meth)acryloxyethoxy]phenyl}fluorene, and 9,9′-bis{3,5-dimethyl-4-[2-[2-(meth)acryloxyethoxy]ethoxy]phenyl}fluorene.

A non-limiting example of the 9,9′-bis{di[2-(meth)acryloxyalkoxy]phenyl}fluorene compounds is 9,9′-bis{3,5-di[2-(meth)acryloxyethoxy]phenyl}fluorene.

A non-limiting example of the 9,9′-bis{tri[2-(meth)acryloxyalkoxy]phenyl}fluorene compounds is 9,9′-bis{3,4,5-tri[2-(meth)acryloxyethoxy]phenyl}fluorene.

A non-limiting example of the 9,9′-bis{[phenyl-(meth)acryloxyalkoxy]phenyl}fluorene compounds is 9,9′-bis{3-phenyl-4-[2-(meth)acryloxyethoxy]phenyl}fluorene.

Examples of the 9,9′-bis{[(meth)acryloxyalkoxy]naphthyl}fluorene compounds include, but are not limited to, 9,9′-bis{6-[2-(meth)acryloxyethoxy]-2-nathphyl}fluorene, 9,9′-bis{6-[2-(meth)acryloxyethoxy]-1-nathphyl}fluorene, 9,9′-bis{5-[2-(meth)acryloxyethoxy]-2-nathphyl}fluorene, and 9,9′-bis{5-[2-(meth)acryloxyethoxy]-1-nathphyl}fluorene.

Preferably, the fluorene derivative compound is selected from 9,9′-bis[4-(2-methacryloxyethoxy)phenyl]fluorene, 9,9′-bis[3-methyl-4-(2-acryloxypropoxy)phenyl]fluorene, 9,9′-bis[3-phenyl-4-(2-methacryloxyethoxy)phenyl]fluorene, and 9,9′-bis[6-(2-acryloxyethoxy)-1-naphthyl]fluorene.

The aforesaid examples of the fluorene derivative compound can be used alone or as a mixture of two or more.

Examples of the commercially available products of the fluorene derivative compounds include, but are not limited to, OGSOL series of Osaka Gas Chemicals, for example, EA-0200, EA-0500, EA-1000, EA-F5003, EA-F5503, EA-F5510, and the like; and A-BPEF of Shin-Nakamura Chemical Co., Ltd.

The fluorene derivative component (C) is used in an amount ranging from 5 parts by weight to 120 parts by weight, preferably from 10 parts by weight to 100 parts by weight, and more preferably from 20 parts by weight to 80 parts by weight based on 100 parts by weight of the polysiloxane component (A).

If the fluorene derivative compound having at least one double-bond-containing group is not contained in the fluorene derivative (C), a protective film with an intimate structure cannot be formed by a bridging reaction between the alkenyl group contained in the polysiloxane and the double-bond-containing group contained in the fluorene derivative compound. Undesirable swelling effect due to the solvent may occur, and the chemical resistance of the protective film thus formed is inferior. Moreover, since the fluorene derivative compound having at least one double-bond-containing group is relatively inert to the development solution, the development resistance of the protective film can be effectively enhanced.

### Solvent (D):

There is no specific limitation to the solvent (D) suitable in the photo-curing polysiloxane composition of the present invention. Examples of the solvent (D) include, but are not limited to, an alcoholic hydroxyl-containing compound, and a carbonyl-containing cyclic compound. The aforesaid examples of solvent (D) can be used alone or as a mixture of two or more.

Examples of the alcoholic hydroxyl-containing compound include, but are not limited to, acetol, 3-hydroxy-3-methyl-2-butanone, 4-hydroxy-3-methyl-2-butanone, 5-hydroxy-2-pentanone, 4-hydroxy-4-methyl-2-pentanone (diacetone alcohol, abbreviated as DAA), ethyl lactate, butyl lactate, propylene glycol monomethyl ether, propylene glycol monoethyl ether (abbreviated as PGEE), propylene glycol monomethylether acetate (abbreviated as PGMEA), propylene glycol mono-n-propyl ether, propylene glycol mono-n-butyl ether, propylene glycol mono-t-butyl ether, 3-methoxy-1-butanol, 3-methyl-3-methoxy-1-butanol, and combinations thereof. The aforesaid examples of the alcoholic hydroxyl-containing compound can be used alone or as a mixture of two or more.

Preferably, the alcoholic hydroxyl-containing compound is selected from diacetone alcohol, ethyl lactate, propylene glycol monoethyl ether, propylene glycol monomethylether acetate, and combinations thereof.

Examples of the carbonyl-containing cyclic compound include, but are not limited to, γ-butyrolactone, γ-valerolactone, δ-valerolactone, propylene carbonate, N-methylpyrrolidone, cyclohexanone, and cycloheptanone. The aforesaid examples of the carbonyl-containing cyclic compound can be used alone or as a mixture of two or more.

Preferably, the carbonyl-containing cyclic compound is selected from γ-butyrolactone, N-methylpyrrolidone, cyclohexanone, and combinations thereof.

When the alcoholic hydroxyl-containing compound and the carbonyl-containing cyclic compound are used in combination, there is no specific limitation to the weight ratio thereof. The weight ratio of the alcoholic hydroxyl-containing compound to the carbonyl-containing cyclic compound ranges preferably from 99/1 to 50/50, and more preferably from 95/5 to 60/40. It should be noted that, when the weight ratio of the alcoholic hydroxyl-containing compound to the carbonyl-containing cyclic compound ranges from 99/1 to 50/50, it is less likely for the unreactive silanol group in the polysiloxane component (A) to undergo condensation reaction that may reduce the storage stability. Moreover, the miscibility between the polysiloxane component (A) and the quinonediazide compound (B) is good so that it is less likely to opaque the protective film, thereby maintaining the transparency of the protective film formed thereby.

Further solvents other than the aforesaid solvent can be included in the photo-curing polysiloxane composition of the present invention as long as the desirable effects obtainable by the photo-curing polysiloxane composition are not impaired. Examples of the further solvents include, but are not limited to:

(1) esters, for example, ethyl acetate, n-propyl acetate, isopropyl acetate, n-butyl acetate, isobutyl acetate, propylene glycol monomethyl ether acetate, 3-methoxy-1-butyl acetate, 3-methyl-3-methoxy-1-butyl acetate, and the like;
(2) ketones, for example, methyl isobutyl ketone, diisopropyl ketone, diisobutyl ketone, and the like; (3) ethers, for example, diethyl ether, diisopropyl ether, di-n-butyl ether, diphenyl ether, and the like.

The solvent (D) is used in an amount ranging generally from 50 parts by weight to 1,200 parts by weight, preferably from 80 parts by weight to 1,000 parts by weight, and more preferably from 100 parts by weight to 800 parts by weight based on 100 parts by weight of polysiloxane component (A).

### Thermopolymerization Initiator (E):

Preferably, the photo-curing polysiloxane composition further includes a thermopolymerization initiator (E).

Examples of the thermopolymerization initiator (E) include, but are not limited to (1) azo compounds, (2) organic peroxide compounds, and (3) hydrogen peroxide compounds, and can be used alone or as a mixture of two or more.

Examples of the azo compounds include, but are not limited to, azobis(isobutyronitrile), 2,2′-azobis(2-methyl butyronitrile), 1,1′-azobis(cyclohexane-1-carbonitrile), 2,2′-azobis(2,4-dimethylvaleronitrile), 1-[(1-cyano-1-methylethyl)azo]formamide, 2,2-azobis(2-methyl-N-[1,1-bis(hydroxymethyl)-2-hydroxyethyl]propionamide, 2,2′-azobis[N-(2-propenyl)-2-methylpropionamide, 2,2′-azobis[N-(2-propenyl)-2-ethyl propionamide, 2,2′-azobis(N-butyl-2-methylpropionamide), 2,2′-azobis(N-cyclohexyl-2-methyl propionamide), 2,2′-azobis(dimethyl-2-methyl propionamide), 2,2′-azobis(dimethyl-2-methylpropionate), and 2,2′-azobis(2,4,4-trimethyl pentene). The aforesaid examples of the azo compounds can be used alone or as a mixture of two or more.

Examples of the organic peroxide compounds include, but are not limited to, benzoyl peroxide, di-t-butyl peroxide, diisobutyryl peroxide, cumyl peroxyneodecanoate, di-n-propyl peroxydicarbonate, diisopropyl peroxydicarbonate, di-sec-butyl peroxydicarbonate, 1,1,3,3-tetramethylbutyl peroxyneodecanoate, di(4-t-butyl cyclohexyl)peroxydicarbonate, 1-cyclohexyl-1-methyl ethyl peroxyneodecanoate, di(2-ethoxy-ethyl)peroxydicarbonate, di(2-ethyl hexyl)peroxydicarbonate, t-hexyl peroxyneodecanoate, dimethoxybutyl peroxydicarbonate, t-butyl peroxyneodecanoate, t-hexyl peroxypivalate, t-butyl peroxypivalate, di(3,5,5-trimethyl hexanoyl)peroxide, di-n-octanoyl peroxide, dilauroyl peroxide, distearoyl peroxide, 1,1,3,3-tetramethylbutylperoxy-2-ethylhexanoate, 2,5-dimethyl-2,5-di(2-ethylhexanoylperoxy)hexane, t-hexylperoxy-2-ethylhexanoate, di(4-methylbenzoyl)peroxide, t-butylperoxy-2-ethylhexanoate, dibenzoyl peroxide, t-butyl peroxyisobutyrate, 1,1-di(t-butylperoxy)-2-methylcyclohexane, 1,1-di(t-hexyl peroxy)-3,3,5-trimethylcyclohexane, 1,1-di(t-hexyl peroxy)cyclohexane, 1,1-di(t-butylperoxy)cyclohexane, 2,2-di[4,4-di(t-butylperoxy)cyclohexyl]propane, t-hexyl peroxy isopropyl monocarbonate, t-butylperoxy maleate, t-butyl peroxy-3,5,5-trimethyl hexanoate, t-butyl peroxy laurate, 2,5-dimethyl-2,5-di-(3-methyl benzoyl peroxy)hexane, t-butyl peroxy isopropyl monocarbonate, t-butyl peroxy-2-ethylhexyl monocarbonate, t-hexyl peroxy benzoate, 2,5-dimethyl-2,5-di(benzoyl peroxy)hexane, t-butyl peroxy acetate, 2,2-di(t-butylperoxy)butane, t-butyl peroxy benzoate, n-butyl-4,4-di(t-butylperoxy)valerate, di(2-t-butyl peroxy isopropyl)benzene, dicumyl peroxide, di-t-hexyl peroxide, 2,5-dimethyl-2,5-di(t-butyl peroxy)hexane, di-t-butyl peroxide, 2,5-dimethyl-2,5-di(t-butylperoxy)hexyne-3, t-butyl trimethylsilyl peroxide, di(3-methylbenzoyl)peroxide, and a combination of benzoyl (3-methylbenzoyl)peroxide] with dibenzoyl peroxide. The aforesaid examples of the organic peroxide compounds can be used alone or as a mixture of two or more.

Examples of the hydrogen peroxide compounds include, but are not limited to, p-menthane hydroperoxide, diisopropylbenzene hydroperoxide, 1,1,3,3-tetramethyl butyl hydroperoxide, cumene hydroperoxide, and t-butyl hydroperoxide. The aforesaid examples of the hydrogen peroxide compounds can be used alone or as a mixture of two or more.

Preferably, the thermopolymerization initiator (E) is selected from 2,2′-azobis(isobutyronitrile), 2,2′-azobis(2-methyl butyronitrile, 2,2′-azobis(2,4-dimethylvaleronitrile), diisobutyryl peroxide, dibenzoyl peroxide, t-butyl peroxyisobutyrate, cumene hydroperoxide, and cumyl peroxyneodecanoate.

The thermopolymerization initiator (E) is used in an amount ranging generally from 0.5 part by weight to 20 parts by weight, preferably from 1 part by weight to 15 parts by weight, and more preferably from 1 part by weight to 10 parts by weight based on 100 parts by weight of the polysiloxane component (A).

The thermopolymerization initiator (E) is used to enhance the bridging reaction between the polysiloxane having at least one alkenyl group and the fluorene derivative compound having at least one double-bond-containing group so as to form a protective film having an intimate structure. Therefore, undesirable swelling effect due to the solvent can be alleviated or even eliminated so as to enhance the chemical resistance of the protective film.

### Additives (F):

Additives (F) can be optionally added to the photo-curing polysiloxane composition, and include, but are not limited to, a sensitizer, an adhesion auxiliary agent, a surfactant, a solubility promoter, a defoamer, and combinations thereof.

There is no specific limitation to the sensitizer. Preferably, the sensitizer is a phenolic hydroxyl-containing compound, for example, but not limited to:

(1) trisphenol type compounds, for example, tri(4-hydroxyphenyl)methane, bis(4-hydroxy-3-methylphenyl)-2-hydroxyphenylmethane, bis(4-hydroxy-2,3,5-trimethylphenyl)-2-hydroxyphenylmethane, bis(4-hydroxy-3,5-dimethylphenyl)-4-hydroxyphenylmethane, bis(4-hydroxy-3,5-dimethylphenyl)-3-hydroxyphenylmethane, bis(4-hydroxy-3,5-dimethylphenyl)-2-hydroxyphenylmethane, bis(4-hydroxy-2,5-dimethylphenyl)-4-hydroxyphenyl methane, bis(4-hydroxy-2,5-dimethylphenyl)-3-hydroxyphenylmethane, bis(4-hydroxy-2,5-dimethylphenyl)-2-hydroxyphenylmethane, bis(4-hydroxy-3,5-dimethylphenyl)-3,4-dihydroxyphenylmethane, bis(4-hydroxy-2,5-dimethylphenyl)-3,4-dihydroxyphenylmethane, bis(4-hydroxy-2,5-dimethylphenyl)-2,4-dihydroxyphenyl methane, bis(4-hydroxyphenyl)-3-methoxy-4-hydroxyphenylmethane, bis(5-cyclohexyl-4-hydroxy-2-methylphenyl)-4-hydroxyphenyl methane, bis(5-cyclohexyl-4-hydroxy-2-methylphenyl)-3-hydroxyphenylmethane, bis(5-cyclohexyl-4-hydroxy-2-methylphenyl)-2-hydroxyphenylmethane, bis(5-cyclohexyl-4-hydroxy-2-methylphenyl)-3,4-dihydroxyphenylmethane, and the like; (2) bisphenol type compounds, for example, bis(2,3,4-trihydroxyphenyl)methane, bis(2,4-dihydroxyphenyl)methane, 2,3,4-trihydroxyphenyl-4′-hydroxyphenylmethane, 2-(2,3,4-trihydroxyphenyl)-2-(2′,3′,4′-trihydroxyphenyl)propane, 2-(2,4-dihydroxyphenyl)-2-(2′,4′-dihydroxyphenyl)propane, 2-(4-hydroxyphenyl)-2-(4′-hydroxyphenyl)propane, 2-(3-fluoro-4-hydroxyphenyl)-2-(3′-fluoro-4′-hydroxyphenyl)propane, 2-(2,4-dihydroxyphenyl)-2-(4′-hydroxyphenyl)propane, 2-(2,3,4-trihydroxyphenyl)-2-(4′-hydroxyphenyl)propane, 2-(2,3,4-trihydroxyphenyl)-2-(4′-hydroxy-3′,5′-dimethylphenyl)propane, and the like; (3) polynuclear branched compounds, for example, 1-[1-(4-hydroxyphenyl)isopropyl]-4-[1,1-bis(4-hydroxyphenyl)ethyl]benzene, 1-[1-(3-methyl-4-hydroxyphenyl)isopropyl]-4-[1,1-bis(3-methyl-4-hydroxyphenyl)ethyl]benzene, and the like; (4) condensation type phenol compounds, for example, 1,1-bis(4-hydroxyphenyl)cyclohexane, and the like; (5) polyhydroxy benzophenones, for example, 2,3,4-trihydroxybenzophenone, 2,4,4′-trihydroxybenzophenone, 2,4,6-trihydroxybenzophenone, 2,3,4-trihydroxy-2′-methylbenzophenone, 2,3,4,4′-tetrahydroxybenzophenone, 2,4,2′,4′-tetrahydroxybenzophenone, 2,4,6,3′,4′-pentahydroxybenzophenone, 2,3,4,2′,4′-pentahydroxybenzophenone, 2,3,4,2′,5′-pentahydroxybenzophenone, 2,4,6,3′,4′,5′-hexahydroxybenzophenone, 2,3,4,3′,4′,5′-hexahydroxybenzophenone, and the like; and (6) combinations thereof.

The sensitizer is used in an amount ranging preferably from 5 to 50 parts by weight, more preferably from 8 to 40 parts by weight, and most preferably from 10 to 35 parts by weight based on 100 parts by weight of the polysiloxane component (A).

The adhesion auxiliary agent is used to enhance the adhesion of the photo-curing polysiloxane composition of the present invention to a substrate containing a semiconductor material. Examples of the adhesion auxiliary agent include, but are not limited to, melamine compounds and silane compounds. Examples of the commercially available products of the melamine compounds include, but are not limited to, Cymel-300, Cymel-303, and the like manufactured by Mitsui Chemicals; and MW-30 MH, MW-30, MS-11, MS-001, MX-750, MX-706, and the like manufactured by Sanwa Chemical. Examples of the silane compounds include, but are not limited to, vinyltrimethoxysilane, vinyltriethoxysilane, 3-acryloxypropyltrimethoxy silane, vinyltri(2-methoxyethoxy)silane, N-(2-aminoethyl)-3-aminopropylmethyldimethoxysilane, N-(2-aminoethyl)-3-aminopropyltrimethoxysilane, 3-aminopropyltriethoxysilane, 3-glycidoxypropyltrimethoxysilane, 3-glycidoxypropyldimethylmethoxysilane, 2-(3,4-epoxycyclohexyl)ethyltrimethoxysilane, 3-chloropropylmethyldimethoxysilane, 3-chloropropyltrimethoxysilane, 3-methylallyloxypropyltrimethoxysilane, 3-mercaptopropyltrimethoxysilane, and commercially available products manufactured by Shin-Etsu Chemical Co., Ltd. (for example, KMB403).

The melamine compounds used as the adhesion auxiliary agent are in an amount ranging preferably from 0 to 20 parts by weight, more preferably from 0.5 part by weight to 18 parts by weight, and most preferably from 1.0 part by weight to 15 parts by weight based on 100 parts by weight of the polysiloxane component (A).

The silane compounds used as the adhesion auxiliary agent are in an amount ranging preferably from 0 to 2 parts by weight, more preferably from 0.05 part by weight to 1 part by weight, and most preferably from 0.1 part by weight to 0.8 part by weight based on 100 parts by weight of the polysiloxane component (A).

Examples of the surfactant include, but are not limited to, anionic surfactant, cationic surfactant, nonionic surfactant, amphoteric surfactant, polysiloxane surfactant, fluorinated surfactant, and combinations thereof. Examples of the surfactant include, but are not limited to: (1) polyoxyethylene alkyl ethers, for example, polyoxyethylene lauryl ether, and the like; (2) polyoxyethylene alkyl phenyl ethers, for example, polyoxyethylene octyl phenyl ether, polyoxyethylene nonyl phenyl ether, and the like; (3) polyethylene glycol diesters, for example, polyethylene glycol dilaurate, polyethylene glycol distearate, and the like; (4) sorbitan fatty acid esters; (5) fatty acid modified polyesters; and (6) tertiary amine modified polyurethanes, and the like. Examples of commercially available products of the surfactant include KP (manufacture by Shin-Etsu Chemical Co., Ltd.), SF-8427 (manufactured by Toray Dow Corning Silicone), Polyflow (manufactured by Kyoeisha Chemical Co., Ltd.), F-Top (manufactured by Tochem Product Co., Ltd.), Megaface (manufactured by DIC), Fluorade (manufactured by Sumitomo 3M), Surflon (manufactured by Asahi Glass), SINOPOL E8008 (manufactured by Sino-Japan Chemical Co., Ltd.), F-475 (manufactured by DIC), and combinations thereof.

The surfactant is used in an amount ranging from 0.5 part by weight to 50 parts by weight, preferably from 1 part by weight to 40 parts by weight, and more preferably from 3 parts by weight to 30 parts by weight based on 100 parts by weight of the polysiloxane component (A).

Examples of the defoamer include, but are not limited to, Surfynol MD-20, Surfynol MD-30, EnviroGem AD01, EnviroGem AE01, EnviroGem AE02, Surfynol DF 110D, Surfynol 104E, Surfynol 420, Surfynol DF 37, Surfynol DF 58, Surfynol DF 66, Surfynol DF 70, and Surfynol DF 210 (manufactured by Air products).

The defoamer is used in an amount ranging preferably from 1 part to 10 parts by weight, more preferably from 2 parts to 9 parts by weight, and most preferably from 3 parts to 8 parts by weight based on 100 parts by weight of the polysiloxane component (A).

Examples of the solubility promoter include, but are not limited to, N-hydroxydicarboxylic imide compounds, and phenolic hydroxyl compounds, for example, the hydroxyl compounds used for manufacturing the quinonediazide compound (B).

The solubility promoter is used in an amount ranging preferably from 1 part by weight to 20 parts by weight, more preferably from 2 parts by weight to 15 parts by weight, and most preferably from 3 parts by weight to 10 parts by weight based on 100 parts by weight of the polysiloxane compound (A).

The photo-curing polysiloxane composition of the present invention is manufactured by stirring the polysiloxane component (A), the quinonediazide compound (B), the fluorene derivative component (C), and the solvent (D) optionally together with the thermopolymerization initiator (E) and the additives (F) in a stirrer to form a homogeneous solution.

A protective film of the present invention is formed by coating the photo-curing polysiloxane composition onto a substrate followed by pre-bake, exposure, development, and post-bake treatments.

The photo-curing polysiloxane composition is applied on the substrate by spin coating, slit coating, roller coating, or the like, and is then prebaked to remove the solvent and to form a prebaked coating film. The conditions for the prebaking depend on the types and the formulating ratio of the components for the photo-curing polysiloxane composition. However, the prebaking is usually conducted at a temperature ranging from 70° C. to 110° C. for a period ranging from 1 minute to 15 minutes. The prebaked coating film is exposed via a photomask using ultraviolet light, such as g-line, h-line, i-line, or the like. The device for providing the ultraviolet light includes a (ultra-) high pressure mercury lamp, and a metal halide lamp. The prebaked coating film after exposing is immersed in a developer solution at a temperature of 23±2° C. for a period ranging from 15 seconds to 5 minutes so as to form a desired pattern. Examples of the developer include alkali compounds, such as sodium hydroxide, potassium hydroxide, sodium carbonate, sodium hydrogen carbonate, potassium carbonate, potassium hydrogen carbonate, sodium silicate, sodium methylsilicate, aqueous ammonia, ethylamine, diethylamine, dimethyl ethanolamine, tetramethylammonium hydroxide, tetraethylammonium hydroxide, choline, pyrrole, piperidine, 1,8-diazabicyclo-[5,4,0]-7-undecene, and the like.

The developer solution is used to reveal defined patterns after exposing the photo-curing polysiloxane composition. When the concentration of the developer solution is too high, the specific patterns will be damaged or have deteriorated resolution. When the concentration of the developer solution is too low, the specific patterns will not be formed or residue after developing may be formed due to poor development. The concentration of the developer solution will influence the patterns formed by the photo-curing polysiloxane composition after exposure. Preferably, the developer solution is used in a concentration ranging preferably from 0.001 wt % to 10 wt %, more preferably from 0.005 wt % to 5 wt %, and even more preferably from 0.01 wt % to 1 wt %.

The developer solution is removed by washing with water after developing. The coating film formed on the substrate is dried with compressed air or nitrogen, and is then post-baked using a heating device, such as a hot plate or an oven. The post-baking is conducted at a temperature ranging from 100° C. to 250° C. for a period ranging from 1 minute to 60 minutes if the hot plate is used or for a period ranging from 5 minutes to 90 minutes if the oven is used. A protective film is formed on the substrate after the process mentioned above.

Examples of the substrate suitable for the present invention include alkali-free glass, soda-lime glass, Pyrex glass, quartz glass, a glass coated with a transparent conductive film thereon, and the like commonly used in a liquid crystal display; and a photoelectric conversion substrate (for example, a silicon substrate) used in a solid-state image sensor.

An element including the substrate and the protective film formed from the photo-curing polysiloxane composition of the present invention applied on the substrate can be used in a display device, a semiconductor device, an optical waveguide device, and the like.

The following examples are provided to illustrate the preferred embodiments of the invention, and should not be construed as limiting the scope of the invention.

### EXAMPLES

### Preparation of Polysiloxane Having at Least One Alkenyl Group

### Preparation Example A-1

A 500 ml three-necked flask was added with methyltrimethoxysilane (referred to as MTMS, 0.3 mole), phenyltrimethoxysilane (referred to as PTMS, 0.55 mole), vinyltrimethoxysilane (abbreviated as VTMS, 0.01 mole), GF-20 (0.05 mole), and propylene glycol monoethyl ether (referred to as PGEE, 200 g). Stirring was conducted at room temperature while an aqueous oxalic acid solution (0.40 g oxalic acid/75 g H₂O) was added over 30 minutes. The mixture in the flask was then stirred in an oil bath at a temperature of 30° C. for 30 minutes. The temperature of the oil bath was raised to 120° C. within a succeeding 30 minutes. When the temperature of the mixture in the flask reached 105° C., the mixture in the flask was stirred for a further 6 hours to carry out polycondensation reaction. Polysiloxane (A-1) having anhydride and alkenyl groups was obtained after distillation to remove the solvent.

### Preparation Example A-2

A 500 ml three-necked flask was added with MTMS (0.60 mole), phenyltriethoxysilane (referred to as PTES, 0.30 mole), 3-acryoyloxypropyltrimethoxysilane (referred to as APP-TMS, 0.05 mole), TMSOX-D (0.04 mole), DMS-S27 (0.01 mole), and PGEE (200 g). Stirring was conducted at room temperature while an aqueous oxalic acid solution (0.45 g oxalic acid/75 g H₂O) was added over 30 minutes. The mixture in the flask was then stirred in an oil bath at a temperature of 30° C. for 30 minutes. The temperature of the oil bath was raised to 120° C. within a succeeding 30 minutes. When the temperature of the mixture in the flask reached 110° C., the mixture in the flask was stirred for a further 6 hours to carry out polycondensation reaction. Polysiloxane (A-2) having epoxy and alkenyl groups was obtained after distillation to remove the solvent.

### Preparation Example A-3

A 500 ml three-necked flask was added with dimethyldimethoxysilane (referred to as DMDMS, 0.60 mole), PTMS (0.30 mole), 3-methylacryloyloxypropyltrimethoxysilane (referred to as MAPP-TMS, 0.10 mole), PGEE (100 g), and diacetone alcohol (referred to as DAA, 100 g). Stirring was conducted at room temperature while an aqueous oxalic acid solution (0.35 g oxalic acid/75 g H₂O) was added over 30 minutes. The mixture in the flask was then stirred in an oil bath at a temperature of 30° C. for 30 minutes. The temperature of the oil bath was raised to 120° C. within a succeeding 30 minutes. When the temperature of the mixture in the flask reached 105° C., the mixture in the flask was stirred for a further 6 hours to carry out polycondensation reaction to form Polysiloxane (A-3) having an alkenyl group.

### Preparation Example A-4

A 500 ml three-necked flask was added with MTMS (0.30 mole), DMDMS (0.30 mole), PIES (0.25 mole), VTMS (0.05 mole), APP-TMS (0.10 mole), and PGEE (200 g). Stirring was conducted at room temperature while an aqueous oxalic acid solution (0.40 g oxalic acid/75 g H₂O) was added over 30 minutes. The mixture in the flask was then stirred in an oil bath at a temperature of 30° C. for 30 minutes. The temperature of the oil bath was raised to 120° C. within a succeeding 30 minutes. When the temperature of the mixture in the flask reached 110° C., the mixture in the flask was stirred for a further 6 hours to carry out polycondensation reaction. Polysiloxane (A-4) having an alkenyl group was obtained after distillation to remove the solvent.

### Preparation Example A-5

A 500 ml three-necked flask was added with DMDMS (0.40 mole), PTMS (0.40 mole), PIES (0.15 mole), GF-20 (0.03 mole), 3-(trimethoxysilyl)propyl glutaric anhydride (referred to as TMSG, 0.02 mole), DAAS (100 g), and PGEE (100 g). Stirring was conducted at room temperature while an aqueous oxalic acid solution (0.40 g oxalic acid/75 g H₂O) was added over 30 minutes. The mixture in the flask was then stirred in an oil bath at a temperature of 30° C. for 30 minutes. The temperature of the oil bath was raised to 120° C. within a succeeding 30 minutes. When the temperature of the mixture in the flask reached 110° C., the mixture in the flask was stirred for a further 5 hours to carry out polycondensation reaction. Polysiloxane (A-5) having an anhydride group was obtained after distillation to remove the solvent.

### Preparation Example A-6

A 500 ml three-necked flask was added with MTMS (0.75 mole), PTMS (0.25 mole), and PGEE (200 g). Stirring was conducted at room temperature while an aqueous oxalic acid solution (0.45 g oxalic acid/75 g H₂O) was added over 30 minutes. The mixture in the flask was then stirred in an oil bath at a temperature of 30° C. for 30 minutes. The temperature of the oil bath was raised to 120° C. within a succeeding 30 minutes. When the temperature of the mixture in the flask reached 105° C., the mixture in the flask was stirred for a further 6 hours to carry out polycondensation reaction. Polysiloxane (A-6) was obtained after distillation to remove the solvent.

The types and the amounts of the silane monomer components, the solvents, and the catalysts and the reaction conditions used in Preparation Examples A-1 to A-6 are listed in Table 1.

TABLE 1

| | Polysiloxane Components | | | | | | | | | | |
|---|---|---|---|---|---|---|---|---|---|---|---|
| | Silane Monomer Components (mole) | | | | | | | | | | |
| Pre | | | | | | | MAPP- | GF- | | | DMS- |
| Ex | MTMS | DMDMS | PTMS | PTES | VTMS | APP-TMS | TMS | 20 | TMSG | TMSOX-D | S27 |
| A-1 | 0.30 | — | 0.55 | — | 0.10 | — | — | 0.05 | — | — | — |
| A-2 | 0.60 | — | — | 0.30 | — | 0.05 | — | — | — | 0.04 | 0.01 |
| A-3 | — | 0.60 | 0.30 | — | — | — | 0.10 | — | — | — | — |
| A-4 | 0.30 | 0.30 | — | 0.25 | 0.05 | 0.10 | — | — | — | — | — |
| A-5 | — | 0.40 | 0.40 | 0.15 | — | — | — | 0.03 | 0.02 | — | — |
| A-6 | 0.75 | — | 0.25 | — | — | — | — | — | — | — | — |

| | Polysiloxane Components | | | | | |
|---|---|---|---|---|---|---|
| | | | Catalysts (g) | | React. | Polycon. |
| Pre | Solvents (g) | | | Oxalic | Temp. | Time |
| Ex | PGEE | DAA | Water | Acid | (° C.) | (hrs) |
| A-1 | 200 | — | 75 | 0.40 | 105 | 6 |
| A-2 | 200 | — | 75 | 0.45 | 110 | 6 |
| A-3 | 100 | 100 | 75 | 0.35 | 105 | 6 |
| A-4 | 200 | — | 75 | 0.40 | 110 | 6 |
| A-5 | 100 | 100 | 75 | 0.40 | 110 | 5 |
| A-6 | 200 | — | 75 | 0.45 | 105 | 6 |

| | |
|---|---|
| Abbreviation | Chemicals |
| MTMS | methyltrimethoxysilane |
| DMDMS | dimethyldimethoxysilane |
| PTMS | phenyltrimethoxysilane |
| PTES | phenyltriethoxysilane |
| VTMS | vinyltrimethoxysilane |
| APP-TMS | 3-acryoyloxypropyltrimethoxysilane |
| MAPP-TMS | 3-methylacryloyloxypropyltrimethoxysilane |
| GF-20 | 3-(triethoxysilyl)propylsuccinic anhydride |
| TMSG | 3-(trimethoxysilyl)propylglutaric anhydride |
| TMSOX-D | 2-oxetanylbutoxypropyltriethoxysilane |
| DMS-S27 | silanol terminal polysiloxanes manufactured by Gelest Inc. |
| PGEE | propylene glycol monoethyl ether |
| DAA | diacetone alcohol |

### Preparation of Photo-Curing Polysiloxane Composition

### Example 1

100 parts by weight of the polysiloxane (A-1) obtained in Preparation Example A-1, 2 parts by weight of an o-naphthoquinonediazidesulfonic acid ester (DPAP200 manufactured by DKC, average esterification rate: 67%) obtained by reacting 1-[1-(4-hydroxyphenyl)isopropyl]-4-[1,1-bis(4-hydroxyphenyl)ethyl]benzene with o-naphthoquinonediazo-5-sulfonic acid, and 5 parts by weight of 9,9′-bis[4-(2-methacryloxyethoxy)phenyl]fluorene were added into 50 parts by weight of propylene glycol monomethylether acetate (referred to as PGMEA). Stirring was conducted using a shaking type stirrer until a homogenous photo-curing polysiloxane composition was obtained. The obtained photo-curing polysiloxane composition was evaluated according to the following evaluation methods. The evaluation results are shown in Table 2.

### Examples 2 to 10 and Comparative Examples 1 to 13

Examples 2 to 10 and Comparative Examples 1 to 13 were conducted in a manner identical to that of Example 1 using the components and the amounts thereof listed in Tables 2 and 3. The obtained photo-curing polysiloxane compositions of Examples 2 to 10 and Comparative Examples 1 to 13 were evaluated according to the following evaluation methods. The evaluation results are shown in Tables 2 and 3.

### Evaluation Methods:

### 1. Chemical Resistance:

The photo-curing polysiloxane compositions obtained in Examples 1 to 10 and Comparative Examples 1 to 13 were separately spin-coated on glass substrates of 100 mm×100 mm×0.7 mm to obtain pre-coated films of 2 μm in thickness followed by pre-baking at 110° C. for 2 minutes. The pre-coated films were treated with ultra-violet irradiation with energy intensity of 100 mJ/cm² using an exposure machine through suitable photo-masks, and were then immersed in a developer solution of 2.38 wt % tetramethylammonium hydroxide solution at 23° C. for 60 seconds to dissolve the exposed portions of the pre-coated films followed by washing with pure water. The developed films were directly irradiated by the exposure machine with energy intensity of 200 mJ/cm². Post-bake was then conducted at 230° C. for 1 hour. The post-baked films were then immersed in N-methylpyrrolidone solution at 60° C. for 6 minutes. Variations of film thickness were calculated through the following formula:

Variation of film thickness=[(film thickness after immersion−film thickness before immersion)/film thickness before immersion]×100%

The variation of film thickness ranging from −3% to 3% is preferable.

⊚: −3%≦variation of film thickness≦3%;
∘: −5%≦variation of film thickness≦−3% or

3%<variation of film thickness≦5%;

X: variation of film thickness<−5% or

5%<variation of film thickness

### 2. Development Resistance:

The photo-curing polysiloxane compositions obtained in Examples 1 to 10 and Comparative Examples 1 to 13 were separately spin-coated on glass substrates of 100 mm×100 mm×0.7 mm to obtain pre-coated films of 2 μm in thickness followed by pre-baking at 110° C. for 2 minutes. The pre-coated films were then treated with ultra-violet irradiation using an exposure machine (100 mJ/cm²) through suitable positive photo-masks, and were then immersed in a developer solution of 2.38 wt % tetramethylammonium hydroxide at 23° C. for 100 seconds to obtain 100 cylinder patterns with 10 μm in diameter. The evaluation criteria are defined as follows.

∘: less than 10 cylinders are damaged;

X: 10 or more cylinders are damaged.

TABLE 2

| Components | | Examples | | | | | | | | | |
|---|---|---|---|---|---|---|---|---|---|---|---|
| (Parts by weight) | | 1 | 2 | 3 | 4 | 5 | 6 | 7 | 8 | 9 | 10 |
| (A) | A-1 | 100 | — | — | — | 100 | — | 30 | — | 70 | 80 |
| | A-2 | — | 100 | — | — | — | 100 | — | 50 | — | — |
| | A-3 | — | — | 100 | — | — | — | 70 | 50 | — | — |
| | A-4 | — | — | — | 100 | — | — | — | — | 30 | — |
| | A-5 | — | — | — | — | — | — | — | — | — | 20 |
| | A-6 | — | — | — | — | — | — | — | — | — | — |
| (B) | B-1 | 2 | 10 | 10 | 20 | — | 30 | 30 | 30 | 30 | 40 |
| | B-2 | — | — | 5 | — | 20 | — | 20 | 5 | — | — |
| (C) | C-1 | 5 | — | — | — | — | — | 60 | — | 50 | 120 |
| | C-2 | — | 10 | — | — | — | 50 | — | 40 | — | — |
| | C-3 | — | — | 20 | — | 40 | — | — | — | 50 | — |
| | C-4 | — | — | — | 30 | — | — | — | 40 | — | — |
| (D) | C-5 | — | — | — | — | — | — | — | — | — | — |
| | C-6 | — | — | — | — | — | — | — | — | — | — |
| (E) | D-1 | 50 | 300 | 500 | 500 | 500 | 600 | 300 | 1000 | 800 | 800 |
| | D-2 | — | — | — | 100 | — | — | 300 | — | — | — |
| | D-3 | — | — | — | — | 100 | — | — | 200 | — | — |
| | E-1 | — | — | — | 5 | — | 20 | — | — | — | — |
| | E-2 | — | — | — | — | 10 | — | — | — | — | — |
| Evaluation | Chemical Resistance | ◯ | ◯ | ◯ | ⊚ | ⊚ | ⊚ | ◯ | ◯ | ◯ | ◯ |
| Items | Development Resistance | ◯ | ◯ | ◯ | ◯ | ◯ | ◯ | ◯ | ◯ | ◯ | ◯ |

B-1: o-naphthoquinonediazidesulfonic acid ester obtained by reacting 1-[1-(4-hydroxyphenyl)isopropyl]-4-[1,1-bis(4-hydroxyphenyl)ethyl]benzene with o-naphthoquinonediazo-5-sulfonic acid;
B-2: o-naphthoquinonediazidesulfonic acid ester obtained by reacting 2,3,4-trihydroxybenzophenone with o-naphthoquinonediazo-5-sulfonic acid;
C-1: 9,9′-bis[4-(2-methacryloxyethoxy)phenyl]fluorene;
C-2: 9,9′-bis[3-methyl-4-(2-acryloxypropoxy)phenyl]fluorene;
C-3: 9,9′-bis[3-phenyl-4-(2-methacryloxyethoxy)phenyl]fluorene;
C-4: 9,9′-bis[6-(2-acryloxyethoxy)-1-naphthyl]fluorene;
C-5: 9,9′-bis[(4-3-glycidoxy)phenyl]fluorene (manufactured by Osaka Gas Chemicals, OGSOL PG-100);
C-6: 9,9′-bis(4-hydroxyphenyl)fluorene;
D-1: propylene glycol monomethylether acetate;
D-2: diacetone alcohol;
D-3: cyclohexanone;
E-1: 2,2′-azobis(2,4-dimethylvaleronitrile);
E-2: cumyl peroxyneodecanoate.

TABLE 3

| Components | | Comparative Examples | | | | | | | | | | | | |
|---|---|---|---|---|---|---|---|---|---|---|---|---|---|---|
| (Parts by weight) | | 1 | 2 | 3 | 4 | 5 | 6 | 7 | 8 | 9 | 10 | 11 | 12 | 13 |
| (A) | A-1 | — | — | 100 | — | — | — | — | 100 | — | — | — | — | — |
| | A-2 | — | — | — | 100 | — | — | — | — | 100 | — | — | 100 | — |
| | A-3 | — | — | — | — | 100 | — | — | — | — | — | 100 | — | — |
| | A-4 | — | — | — | — | — | — | — | — | — | — | — | — | — |
| | A-5 | — | 100 | — | — | — | 100 | — | — | — | 100 | — | — | — |
| | A-6 | 100 | — | — | — | — | — | 100 | — | — | — | — | — | 100 |
| (B) | B-1 | 30 | 30 | 20 | 20 | 20 | 20 | — | 10 | 30 | — | 20 | 20 | — |
| | B-2 | — | — | — | — | — | — | 20 | 20 | — | 30 | — | — | 20 |
| (C) | C-1 | 30 | — | — | — | — | — | — | — | — | — | — | — | — |
| | C-2 | — | 60 | — | — | — | — | — | — | — | — | — | — | — |
| | C-3 | — | — | — | — | — | — | — | — | — | — | — | — | — |
| | C-4 | — | — | — | — | — | — | — | — | — | — | — | — | — |
| (D) | C-5 | — | — | — | — | — | — | — | 20 | 30 | 40 | — | — | — |
| | C-6 | — | — | — | — | — | — | — | — | — | — | 20 | 30 | 40 |
| (E) | D-1 | 500 | 300 | 300 | 300 | 300 | 500 | 300 | 300 | 300 | 500 | 300 | 300 | 500 |
| | D-2 | — | 200 | — | — | — | — | — | — | — | — | — | 200 | — |
| | D-3 | — | — | — | — | — | — | — | 200 | — | — | — | — | — |
| | E-1 | — | — | — | — | — | — | — | — | — | — | — | — | — |
| | E 2 | — | — | — | — | — | — | — | — | — | — | — | — | — |
| Evaluation | Chemical | x | x | x | x | x | x | x | x | x | x | x | x | x |
| Items | Resistance | | | | | | | | | | | | | |
| | Development | ∘ | ∘ | x | x | x | x | x | x | x | x | x | x | x |
| | Resistance | | | | | | | | | | | | | |

B-1: o-naphthoquinonediazidesulfonic acid ester obtained by reacting 1-[1-(4-hydroxyphenyl)isopropyl]-4-[1,1-bis(4-hydroxyphenyl)ethyl]benzene with o-naphthoquinonediazo-5-sulfonic acid;
B-2: o-naphthoquinonediazidesulfonic acid ester obtained by reacting 2,3,4-trihydroxybenzophenone with o-naphthoquinonediazo-5-sulfonic acid;
C-1: 9,9′-bis[4-(2-methacryloxyethoxy)phenyl]fluorene;
C-2: 9,9′-bis[3-methyl-4-(2-acryloxypropoxy)phenyl]fluorene;
C-3: 9,9′-bis[3-phenyl-4-(2-methacryloxyethoxy)phenyl]fluorene;
C-4: 9,9′-bis[6-(2-acryloxyethoxy)-1-naphthyl]fluorene;
C-5: 9,9′-bis[(4-3-glycidoxy)phenyl]fluorene (manufactured by Osaka Gas Chemicals, OGSOL PG-100);
C-6: 9,9′-bis(4-hydroxyphenyl)fluorene;
D-1: propylene glycol monomethylether acetate;
D-2: diacetone alcohol;
D-3: cyclohexanone;
E-1: 2,2′-azobis(2,4-dimethylvaleronitrile);
E-2: cumyl peroxyneodecanoate.

As shown in the evaluation results of Examples 1 to 10, a protective film with an intimate structure can be formed by a bridging reaction between the alkenyl group contained in the polysiloxane having at least one alkenyl group and the double-bond-containing group contained in the fluorene derivative compound having at least one double-bonding-containing group. Undesirable swelling effect due to the solvent can be alleviated or even eliminated so as to enhance the chemical resistance of the protective film. Moreover, since the fluorene derivative compound having at least one double-bond-containing group is relatively inert to the development solution, the development resistance of the protective film can be effectively enhanced.

The photo-curing polysiloxane compositions in Comparative Examples 1 and 2 do not contain the polysiloxane having at least one alkenyl group. The aforesaid bridging reaction to form the intimate structure cannot be conducted. The protective film thus formed has inferior chemical resistance.

The photo-curing polysiloxane compositions in Comparative Examples 3 to 7 do not contain the fluorene derivative compound having at least one double-bond-containing group. The aforesaid bridging reaction to form the intimate structure cannot be conducted. The protective film thus formed has inferior chemical resistance.

The photo-curing polysiloxane compositions in Comparative Examples 8 and 9 contain the polysiloxane having at least one alkenyl group and the fluorene compound having an epoxy group. Although a bridging reaction is conducted between the alkenyl group of the polysiloxane and the epoxy group of the fluorene compound, the aforesaid intimate structure still cannot be formed. Therefore, the protective film thus formed has relatively inferior chemical resistance. Furthermore, the epoxy group of the fluorene compound is reactive with the developer solution. The pattern of the protective film may be destroyed, and thus has inferior development resistance.

The photo-curing polysiloxane composition in Comparative Example 10 contains the polysiloxane having an anhydride group and the fluorene compound having an epoxy group. Although a bridging reaction is conducted between the anhydride group of the polysiloxane and the epoxy group of the fluorene compound, the aforesaid intimate structure still cannot be formed. Therefore, the protective film thus formed has relatively inferior chemical resistance. Furthermore, the epoxy group of the fluorene compound is reactive with the developer solution. The pattern of the protective film may be destroyed, and thus has inferior development resistance.

The photo-curing polysiloxane compositions in Comparative Examples 11 and 12 contain the polysiloxane having at least one alkenyl group and the fluorene compound having a hydroxyl group. Although a bridging reaction is conducted between the alkenyl group of the polysiloxane and the hydroxyl group of the fluorene compound, the aforesaid intimate structure still cannot be formed. Therefore, the protective film thus formed has relatively inferior chemical resistance. Furthermore, the hydroxyl group of the fluorene compound is reactive with the developer solution. The pattern of the protective film may be destroyed, and thus has inferior development resistance.

The photo-curing polysiloxane composition in Comparative Example 13 contains neither the polysiloxane having at least one alkenyl group nor the fluorene compound having at least one double-bond-containing group. The aforesaid bridging reaction to form the intimate structure cannot be conducted. The protective film thus formed has inferior chemical resistance.

In view of the aforesaid, in the photo-curing polysiloxane composition of the present invention, a protective film with an intimate structure can be formed from the photo-curing polysiloxane composition by a bridging reaction between the alkenyl group contained in the polysiloxane having at least one alkenyl group and the double-bond-containing group contained in the fluorene derivative compound having at least one double-bond-containing group. Undesirable swelling effect due to the solvent can be alleviated or even eliminated so as to enhance the chemical resistance of the protective film. Moreover, since the fluorene derivative compound having at least one double-bond-containing group is relatively inert to the development solution, the development resistance of the protective film can be effectively enhanced.

While the present invention has been described in connection with what are considered the most practical and preferred embodiments, it is understood that this invention is not limited to the disclosed embodiments but is intended to cover various arrangements included within the spirit and scope of the broadest interpretation and equivalent arrangements.

What is claimed is:

1. A photo-curing polysiloxane composition, comprising:
a polysiloxane component including at least one polysiloxane having at least one alkenyl group;
a quinonediazide compound;
a fluorene derivative component including at least one fluorene derivative compound having at least one double-bond-containing group; and
a solvent.

2. The photo-curing polysiloxane composition as claimed in claim 1, wherein said fluorene derivative compound is represented by formula (I): 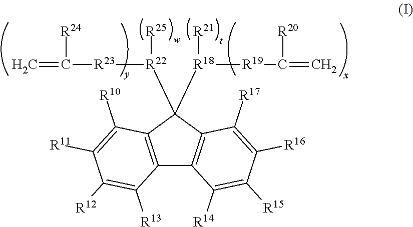
wherein
R¹⁰-R¹⁷ independently represent hydrogen, halo, cyano, or an alkyl group;
R¹⁸ and R²² independently represent an aryl group or a heterocyclic group;
R¹⁹ and R²³ independently represent a single bond or an organic group;
R²⁰ and R²⁴ independently represent hydrogen or methyl;
R²¹ and R²⁵ independently represent hydrogen, halo, an alkyl group, a cycloalkyl group, an aryl group, an alkaryl group, an alkoxyl group, a cycloalkyloxy group, an aryloxy group, an acyl group, nitro, cyano, or amino;
x and y independently represent an integer ranging from 1 to 3; and
w and t independently represent an integer ranging from 0 to 3.

3. The photo-curing polysiloxane composition as claimed in claim 1, wherein said fluorene derivative compound is represented by formula (II): 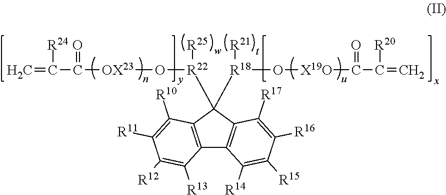
wherein
R¹⁰-R¹⁷ independently represent hydrogen, halo, cyano, or an alkyl group;
R¹⁸ and R²² independently represent an aryl group or a heterocyclic group;
X¹⁹ and X²³ independently represent an alkylene group;
R²⁰ and R²⁴ independently represent hydrogen or methyl;
R²¹ and R²⁵ independently represent hydrogen, halo, an alkyl group, a cycloalkyl group, an aryl group, an alkaryl group, an alkoxyl group, a cycloalkyloxy group, an aryloxy group, an acyl group, nitro, cyano, or amino;
x and y independently represent an integer ranging from 1 to 3;
w and t independently represent an integer ranging from 0 to 3; and
n and u independently represent an integer ranging from 0 to 10.

4. The photo-curing polysiloxane composition as claimed in claim 1, wherein said polysiloxane further has at least one reactive group selected from the group consisting of an anhydride group and an epoxy group.

5. The photo-curing polysiloxane composition as claimed in claim 1, wherein said polysiloxane is obtained by subjecting a silane monomer component to condensation, said silane monomer component including a silane monomer of Formula (a):
(R^{a})ₖSi(OR^{b})₄₋ₖ (a)
wherein
k denotes an integer ranging from 1 to 3,
at least one of R^{a} independently represents a C₂-C₁₀ alkenyl group, and the rest of R^{a} independently represents hydrogen, a C₁-C₁₀ alkyl group, an anhydride-substituted C₁-C₁₀ alkyl group, an epoxy-substituted C₁-C₁₀ alkyl group, an epoxy-substituted alkoxyl group, or a C₆-C₁₅ aryl group, and
R^{b} independently represents hydrogen, a C₁-C₆ alkyl group, a C₃-C₆ acyl group, or a C₆-C₁₅ aryl group.

6. The photo-curing polysiloxane composition as claimed in claim 1, wherein said quinonediazide compound is in an amount ranging from 1 to 50 parts by weight, said fluorene derivative component is in an amount ranging from 5 to 120 parts by weight, and said solvent is in an amount ranging from 50 to 1200 parts by weight based on 100 parts by weight of said polysiloxane component.

7. The photo-curing polysiloxane composition as claimed in claim 1, further comprising a thermopolymerization initiator.

8. The photo-curing polysiloxane composition as claimed in claim 7, wherein said thermopolymerization initiator is in an amount ranging from 0.5 to 20 parts by weight based on 100 parts by weight of said polysiloxane component.

9. A protective film adapted to be formed on a substrate, said protective film being formed by applying the photo-curing polysiloxane composition as claimed in claim 1 on the substrate.

10. An element, comprising a substrate, and the protective film as claimed in claim 9 applied on said substrate.
